(19) United States
(12) Patent Application Publication
(10) Pub. No.: US 2012/0185820 A1
(43) Pub. Date: Jul. 19, 2012

(54) TOOL GENERATOR

(76) Inventors: Suresh Kadiyala, Cupertino, CA (US); Madhavi Kadiyala, Cupertino, CA (US); Sanjay Banerjee, San Jose, CA (US); Satish Padmanabhan, Sunnyvale, CA (US); James Player, Sunnyvale, CA (US)

(21) Appl. No.: 13/008,901

(22) Filed: Jan. 19, 2011

(51) Int. Cl. G06F 9/44

(52) U.S. Cl. 717/100

(57) ABSTRACT

Systems and methods are disclosed to automatically generate software development tools for an automatically generated processor architecture by: receiving a description of a target processor; automatically generating a target compiler using a compiler generator; automatically generating a target assembler using an assembler generator; automatically generating a target linker using a linker generator; automatically generating a target simulator using a simulator generator; automatically generating a target profiler using a profiler generator; iteratively generating a new processor architecture by changing one or more parameters of the processor architecture until all user constraints or requirements are met using the generated target compiler, assembler, linker, simulator, and profiler; for each new processor architecture regenerating the target compiler, assembler, linker, simulator, profiler for the new processor architecture; and synthesizing an optimal generated processor architecture into a computer readable description of the custom integrated circuit for semiconductor fabrication.

The present invention relates to a method for automatically generating software development tools for a custom integrated circuit (IC) or an application-specific integrated circuit (ASIC).

### BACKGROUND

To develop software for a processor, a set of software development tools are needed. These tools include but not limited to the compiler, assembler, linker, simulator, and a profiler shown in FIG. 1.

The compiler takes a high level language like C/C++, etc. and transforms it into the assembly language of a particular processor, like the x86, MIPS, ARM, for example. The assembler takes in the assembly language, either hand written or generated by a compiler, and produces an object file. The object file contains a series of binary instructions understood by a particular processor. Hence, an assembler translates assembly code into binary form, that is understood by a particular processor, like the x86, MIPS, ARM, among others. The linker takes one or more object files produced by the assembler, links them together by performing all the relocations on the binary code, and generates an executable file.

In the process of developing a new processor, since the processor does not exist, usually a simulator is developed, which simulates the processor being designed. The simulator is a software model for the processor under development. The model can vary in range between a functional equivalent of the processor, to a cycle accurate model of the processor. The model is adopted to develop simulator and is a faithful reflection of the processor being designed, and hence is very specific to the processor being designed. The simulator takes in one or more executables (programs) and their corresponding data vectors, and executes the program, just as the processor it is simulating does. The simulator is optionally capable of putting out its execution trace which amounts to both the instruction trace and the data trace.

Software Development Kits (SDKs) always include a debugger for debugging user applications. The debugger is used to debug user programs and support various debug commands like breakpoints, watch points, single stepping, stack tracebacks, for example.

All of these software tools required for software development are specific to a processor, i.e., a C-compiler, assembler, linker, simulator, and debugger needs to be developed for a MIPS processor if one wants to develop software for the MIPS processor, the IBM PowerPC, or the SUN-SPARC, for example. Developing all of these tools takes several man years for each processor.

### SUMMARY

Systems and methods are disclosed to automatically generate software development tools for an automatically generated processor architecture by: receiving a description of a target processor; automatically generating a target compiler using a compiler generator; automatically generating a target assembler using an assembler generator; automatically generating a target linker using a linker generator; automatically generating a target simulator using a simulator generator; automatically generating a target profiler using a profiler generator; iteratively generating a new processor architecture by changing one or more parameters of the processor architecture until all user constraints or requirements are met using the generated target compiler, assembler, linker, simulator, and profiler; for each processor architecture regenerating the target compiler, assembler, linker, simulator, profiler for the each processor architecture; and synthesizing an optimal generated processor architecture into a computer readable description of the custom integrated circuit for semiconductor fabrication.

Implementations of the above aspects may include one or more of the following. The compiler generator reads in a high level description of the processor under consideration. It reads in the semantics of various instructions in the processor ISA, builds a model of the target processor pipeline and the annotated semantic trees for the instructions, and generates the code needed for target processor code generation, call stack layout, register allocation, instruction scheduling, branch prediction, instruction and data prefetches, and various other optimizations that are possible on the target processor. The assembler generator reads in the syntax of the various instructions, their binary encodings, and the possible relocations that need to be applied to the various instructions. Based upon this information, it then generates the assembler. The assembler generator takes in a list of instructions for the target processor, along with their syntax and valid operands, and their ranges, and builds the assembler to check the syntax of the instruction, and encode the instructions as per the processor specifications, and put out any relevant relocation records, for any unresolved symbols. The linker generator generates an object file linker, that takes in object files and libraries, and generates an executable file, with all the relocations applied on the object code. The simulator generator reads in the machine description where the pipeline structure, ISA, the semantics of the instructions, and the characteristics of each of the hardware blocks are defined. Based on the definitions of all the elements of the architecture, the simulator generator generates a cycle accurate model of the processor, including the cache modeling, memory model, and the interrupt model. This simulator is automatically generated by the simulator generator, and the generated simulator accurately reflects the actual hardware model. The profiler generator takes in a description of the target machine registers, and instruction set among others, and generates a profiler for the target processor that generates static as well as dynamic execution profile of an application running on the target machine. The debugger generator takes in a description of the instruction set of a target processor, along with the call stack layout, and generates a debugger that to specific to a target processor. The debugger thus generated can the hooked up to either the cycle based simulator described above, or to the actual hardware chip. The call stack interpretation, unwinding of the call stack, disassembly of instructions, the number and nature of registers on the target machine, are all automatically generated as part of the debugger generator.

Other implementations can include the following. For each architecture optimization iteration, the system can optimize processor scalarity and instruction grouping rules. The system can also optimize the number of cores needed and automatically splits the instruction stream to use the cores effectively. The processor architecture optimization includes changing an instruction set. The system's changing an instruction set includes reducing the number of instructions required and encoding the instructions to improve instruction decode speed and instruction memory size requirements. The processor architecture optimization includes changing one or more of: a register file port, port width, and number of ports to data memory. The processor architecture optimization includes changing one or more of: data memory size, data cache pre-fetch policy, data cache policy Instruction memory size, instruction cache pre-fetch policy and instruction cache policy. The processor architecture optimization includes adding a co-processor. The system can automatically generate a new instructions uniquely customized to the computer readable code to improve performance of the processor architecture. The system includes parsing the computer readable code, and further includes removing dummy assignments; removing redundant loop operations; identifying required memory bandwidth; replacing one or more software implemented flags as one or more hardware flags; and reusing expired variables. The extracting parameters further includes determining an execution cycle time for each line; determining an execution clock cycle count for each line; determining clock cycle count for one or more bins; generating an operator statistic table; generating statistics for each function; and sorting lines by descending order of execution count. The system can mold commonly used instructions into one or more groups and generating a custom instruction for each group to improve performance (instruction molding). The system can determine timing and area costs for the architecture parameter change. Sequences in the program that could be replaced with the IMCs are identified. This includes the ability to rearrange instructions within a sequence to maximize the fit without compromising the functionality of the code. The system can track pointer marching and building statistics regarding stride and memory access patterns and memory dependency to optimize cache pre-fetching and a cache policy.

The system also includes performing static profiling of the computer readable code and/or dynamic profiling of the computer readable code. A system chip specification is designed based on the profiles of the computer readable code. The chip specification can be further optimized incrementally based on static and dynamic profiling of the computer readable code. The computer readable code can be compiled into optimal assembly code, which is linked to generate firmware for the selected architecture. A simulator can perform cycle accurate simulation of the firmware. The system can perform dynamic profiling of the firmware. The method includes optimizing the chip specification further based on profiled firmware or based on the assembly code. The system can automatically generate register transfer level (RTL) code for the designed chip specification. The system can also perform synthesis of the RTL code to fabricate silicon.

Advantages of the preferred embodiments may include one or more of the following. The system significantly reduces the turn- around time and the design cost for development of software development tools for ASICs and ASIPs. This is done by exploiting the application written in “C” with the underlying algorithm in mind, rather than any particular “chip” design. The system then automatically generates a processor based chip design to implement the algorithm, along with the requisite Software Development Kit and firmware that runs on the chip. The process takes a few weeks to come up with a design, vs. several man years of effort for an ASIP/ASIC.

The system can automatically generate a chip design to match the application's requirements by relying on an “Architecture Optimizer” (AO). Based on the algorithm's execution profile obtained from a cycle accurate system level simulator, and the static profile of the algorithm, and the characterization of the various hardware blocks that go into the chip, the AO determines an optimum hardware configuration that would satisfy the vendor requirements of performance, power, and cost. Based upon an analysis of the algorithm, the AO comes up with a proposed chip architecture that would satisfy the performance requirements, as well as optimize the hardware to the algorithm at hand. The AO comes up with an optimal architecture in a series of iterative steps it takes, to converge upon an optimal hardware for the given algorithm.

The system automates the evaluation process so that all costs are taken into consideration and system designer gets the best possible number representation and bit width candidates to evaluate. The method can evaluate the area, timing and power cost of a given architecture in a quick and automated fashion. This methodology is used as a cost computing engine. The method enables the synthesis of the DSP automatically based on the algorithm in an optimal fashion. The system designer does not need to be aware of the hardware area, delay and power cost associated with the choice of a particular representation over another one. The system allows hardware area, delay and power to be modeled as accurately as possible at the algorithm evaluation stage.

Other advantages of the preferred embodiments of the system may include one or more of the following. The system alleviates the problems of chip design and makes it a simple process. The embodiments shift the focus of product development process back from the hardware implementation process back to product specification and computer readable code or algorithm design. Instead of being tied down to specific hardware choices, the computer readable code or algorithm can be implemented on a processor that is optimized specifically for that application. The preferred embodiment generates an optimized processor automatically along with all the associated software tools and firmware applications. This process can be done in a matter of days instead of years as is conventional. The described automatic system removes the risk and makes chip design an automatic process so that the algorithm designers themselves can directly make the hardware chip without any chip design knowledge since the primary input to the system is the computer readable code, model or algorithm specification rather than low level primitives.

Yet other benefits of using the system may include

1) Speed: If chip design cycles become measured in weeks instead of years, the companies using the system can penetrate rapidly changing markets by bringing their products quickly to the market.

2) Cost: The numerous engineers that are usually needed to be employed to implement chips are made redundant. This brings about tremendous cost savings to the companies using the instant system.

3) Optimality: The chips designed using the instant system product have superior performance, area and power consumption.

The instant system is a complete shift in paradigm in methodology used in design of systems that have a digital chip component to it. The system is a completely automated software product that generates digital hardware from algorithms described in C/Matlab, along with a complete set of software development tools that work with the generated digital hardware. The system uses a unique approach to the process of taking a high level language such as C or Matlab to realizable hardware chip, and its associated software development tools. In a nutshell, it makes chip design a completely automated software process.

### BRIEF DESCRIPTION OF THE DRAWINGS

FIG. 1 shows an exemplary set of software development tools for a particular processor.

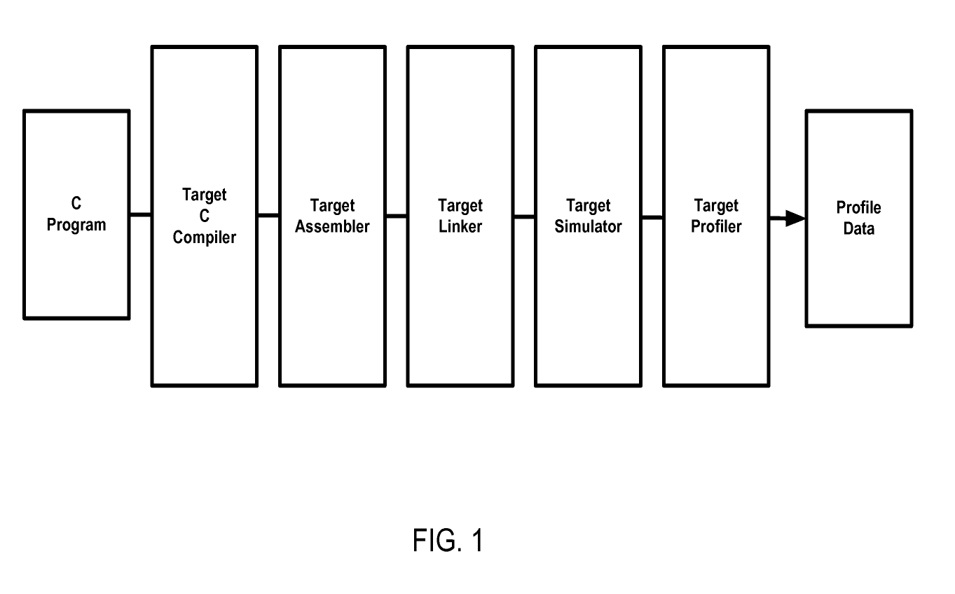

FIG. 2 shows an exemplary system to automatically generate software development tools.

FIG. 2 shows an exemplary system for generating tools customized to an automatically-generated computer architecture using the tools generator of FIG. 2.

FIG. 4 shows an exemplary system to automatically generate a custom IC with the architecture defined by the architecture optimizer.

### DESCRIPTION

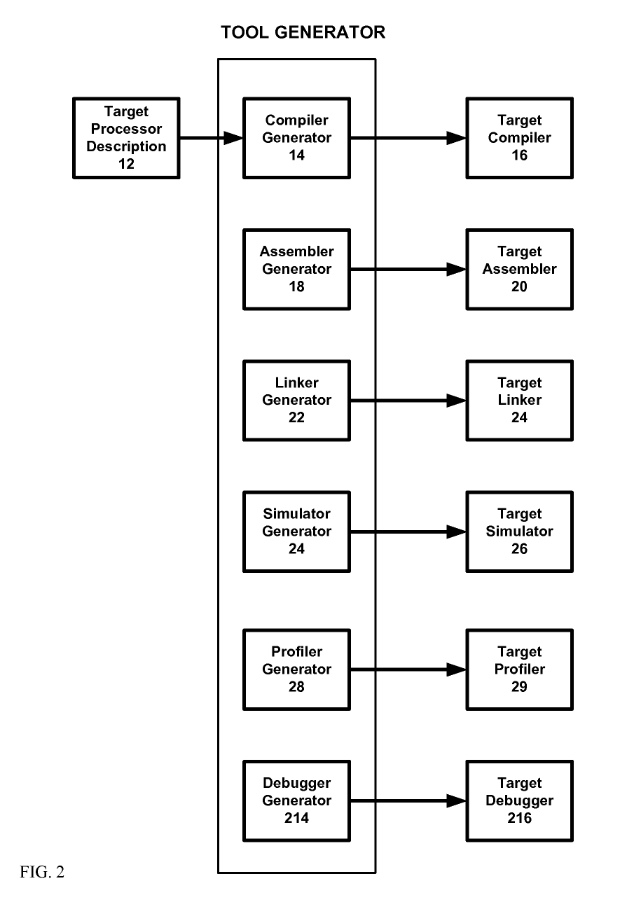

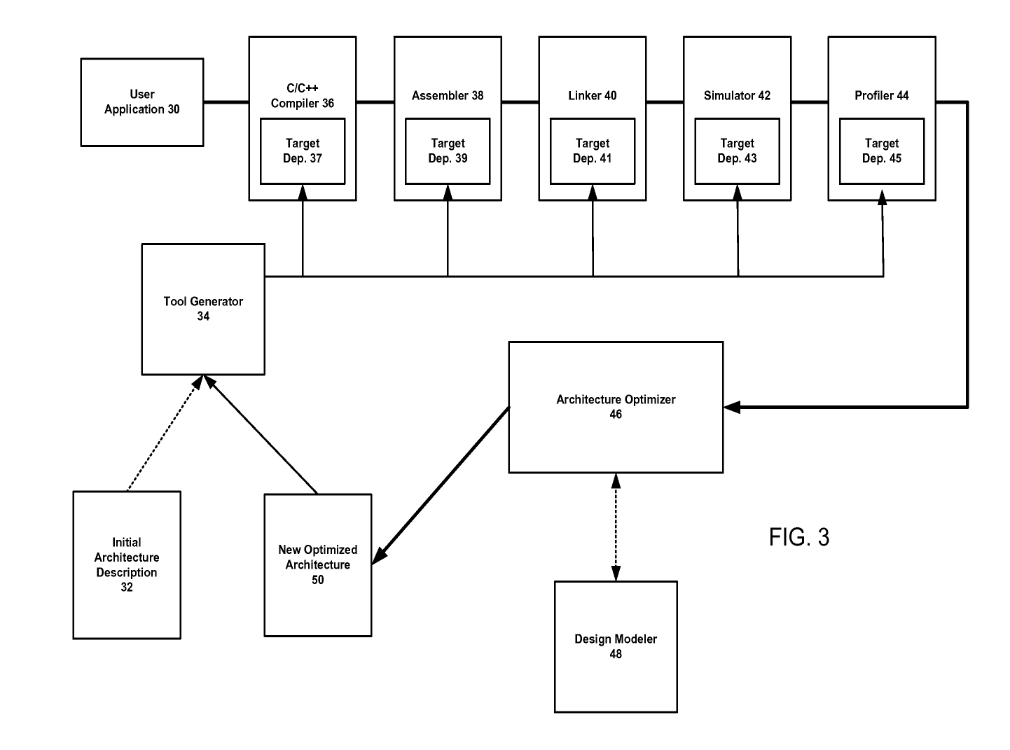

FIG. 2 shows an exemplary system for generating tools customized to an automatically-generated computer architecture. A tool generator receives a set of target processor description files 12. The tool generator is a software module that takes in the description of a target processor and produces the various software development tools.

In the embodiment of FIG. 2, the tool generator consists of a target compiler generator 14, a target assembler generator 18, a target linker generator 22, a target simulator generator 24, a target profiler generator 28, and a target debugger generator 214. All software development tools are then automatically generated by the various tool generators, without any human intervention, just based on the description of the target processor.

The compiler generator 14 reads in a high level description of the processor under consideration. The compiler generator 14 reads in the semantics of various instructions in the processor instruction set architecture (ISA), builds a model of the target processor pipeline and the annotated semantic trees for the instructions, and generates the code needed for target processor code generation, call stack layout, register allocation, instruction scheduling, branch prediction, instruction and data prefetches, and various other optimizations that are possible on the target processor. The result is a target compiler 16.

The assembler generator 18 reads in the syntax of the various instructions, their binary encodings, and the possible relocations that need to be applied to the various instructions. Based upon this information, the assembler generator 18 then generates a target assembler 20. The assembler generator takes in a list of instructions for the target processor, along with their syntax and valid operands, and their ranges, and builds the assembler to check the syntax of the instruction, and encode the instructions as per the processor specifications, and put out any relevant relocation records, for any unresolved symbols.

The linker generator 22 generates target linker 24 with an object file linker that takes in object files and libraries, and generates an executable file, with all the relocations applied on the object code.

The simulator generator 24 reads in the machine description where the pipeline structure, ISA, the semantics of the instructions, and the characteristics of each of the hardware blocks are defined. Based on the definitions of all the elements of the architecture, the simulator generator generates a cycle accurate model of the processor, including the cache modeling, memory model, and the interrupt model. A target simulator 26 is automatically generated by the simulator generator, and the generated simulator accurately reflects the actual hardware model.

A profiler generator 28 can be used to automatically generator a profiler for the target architecture based on the instruction set architecture (ISA) and their semantics. In one embodiment, the target profiler 29 analyzes traces coming out of the target simulator 26 or an actual processor, and generates the static as well as dynamic execution profile of the program at hand. In another embodiment, the target profiler 29 adds profiling code to the entry and exit points of the procedures in a module. This allows a detailed measurement of the number of times a procedure is called, how much time is spent in a procedure in total, and the time spent on average per procedure call. As the measurement itself influences the results, the elapsed times must be regarded in relation to each other.

In one implementation, a debugger generator 214 can be used to generate a target debugger 216. Debugger is a useful tool to debug user applications on a target machine. The debugger generator takes in a description of the instruction set of a target processor, along with the call stack layout, and generates a debugger that is to specific to a target processor. The debugger thus generated can be hooked up to either the cycle based simulator described above, or to the actual hardware chip. The call stack interpretation, unwinding of the call stack, disassembly of instructions, the number and nature of registers on the target machine, are all automatically generated as part of the debugger generator.

The target compiler 16, assembler 20, linker 24, simulator 26, and profiler 29 can be used to automatically determine the best architecture for a custom IC or ASIC device whose functionality is specified by a program, code or computer model. Different stages are involved in obtaining architecture definition for a given computer readable code or program provided as input. In one embodiment, the program is written in the C-language, but other languages such as C++, Matlab, or Java can be used as well. The program is compiled, assembled and linked using the target compiler 16, assembler 20, and linker 24. The executable code is run on the simulator 26 or actual computer. Traces from the execution are provided to the target profiler 29. The information generated by the profiler includes call graphs for static execution and dynamic execution, code execution profile, register allocation information, and current architecture, among others, and the information is provided to an architecture optimizer (AO). The output of the architecture optimizer is an architectural specification that includes pipeline information, compiler calling conventions, register files, cache organization, memory organization, and instruction set architecture (ISA) and instruction set encoding information, among others.

The AO then generates a chip design to match the application's requirements. Based on the algorithm's execution profile it gets from a cycle accurate system level simulator, and the static profile of the algorithm, and the characterization of the various hardware blocks that go into the chip, the AO determines an optimum hardware configuration that would satisfy the vendor requirements of performance, power, and cost. Based upon an analysis of the algorithm, the AO proposes a chip architecture that would satisfy the performance requirements, as well as optimize the hardware to the algorithm at hand. The AO comes up with an optimal architecture in a series of iterative steps that converge upon an optimal hardware for a given algorithm.

The AO determines the optimal architecture for a given algorithm based on a series of hierarchical decisions it makes on various aspects of the ASIP, to match the vendor criteria, so that at no point does it get stuck in achieving a locally minimal architecture. Rather, the AO can design a globally minimal architecture.

The AO can automatically generate an optimal computer architecture to fit a set of algorithms based on the execution profile of the given algorithms. FIG. 3 shows an exemplary system for determining the optimal architecture with the architecture optimizer therein. The system of FIG. 3 uses the automatically generated tools of FIG. 2.

In FIG. 3, a user application 30 is provided as an input. Additionally, an initial architecture description 32 is specified. The architecture description is processed by a tool generator 34 which generates target dependent information for a compiler 36 with target dependencies 37, an assembler 38 with target dependencies 39, a linker 40 with target dependencies 41, a simulator 42 with target dependencies 43, and a profiler 44 with target dependencies 45. Based on the target dependent information, a profile of the user application 30 is generated. The profile identifies critical routines and their kernels (most executed loops). The profile also identifies memory traffic patterns. The profile is provided to an architecture optimizer 46. The architecture optimizer 46 also uses inputs from a design data modeler 48. The design modeler 48 provides timing, area, power, and other relevant information for a particular hardware, and such information can be queried by the architecture optimizer 46 on demand. The output of the optimizer 46 is a new optimized architecture 50. The optimized architecture 50 is then provided to the tool generator 34 for iterative optimization of the architecture until a predetermined optimization goal is reached.

The new architecture is obtained by optimizing each of the components in the architecture, and their overall interconnections. For a given set of applications/algorithms, an optimal computer system architecture can automatically be determined based on the various factors like performance, cost, and power. The optimal architecture can include a system level architecture and a processor level architecture. For the system level architecture, the AO 46 can automatically determine the amount of memory needed, the memory bandwidth to support, the number of DMA channels, clocks, and peripherals, for example. For processor level architecture, the AO can automatically determine: the need for and the amount of scalarity of the computation elements based on the parallelism in the algorithm and the performance criteria set for the system; the types of computation elements needed to efficiently implement a particular algorithm; the number of computation elements needed to efficiently implement the application; the pipeline organization in terms of the number of stages, the instruction issue rate, the scalarity, the number of computation elements in terms of the number of adders, load, store units, etc. and the placement of the computation elements in the pipeline structure; the width of the ALUs (computation elements); the number of register files and their configuration in terms of the number of registers, their widths, the number of read ports and write ports; the need for condition code registers; the need for and the amount of instruction cache, and data cache needed, and their hierarchy; the caching mechanism separately for the instruction cache and data cache, the line sizes, the spill/fill algorithms.

The AO can automatically introduce instruction and data prefetch instructions in the code of the user's algorithm, to do prefetch on demand and at the right time. The AO can determine the write back policies of each of the caches; the number of read and write ports to memory; the bus widths between the caches and the memory; and the levels of cache, and its organization in terms of shared or separate instruction cache and data cache, or a combined cache, or its organization into multiple levels, to reduce the overall cost structure, yet maintain high performance.

The AO can automatically determine memory hierarchy in terms of the memory size, the memory map scheme, the access size, the number of read/write ports and their widths, and how the memory needs to be split up to get the maximum performance. The AO can automatically determine the ISA for the machine to implement the algorithm in an efficient manner, and further automatically determine an optimal encoding for the instruction set, to take the least amount of code space, yet achieve high performance. The AO can also automatically determine the calling conventions that ensure the optimal usage of the available registers.

The foregoing operations can be done iteratively and in a hierarchical fashion to determine the optimal overall system architecture to come up with a chip that is optimized for the application 30, satisfying the given timing, cost, and power requirements.

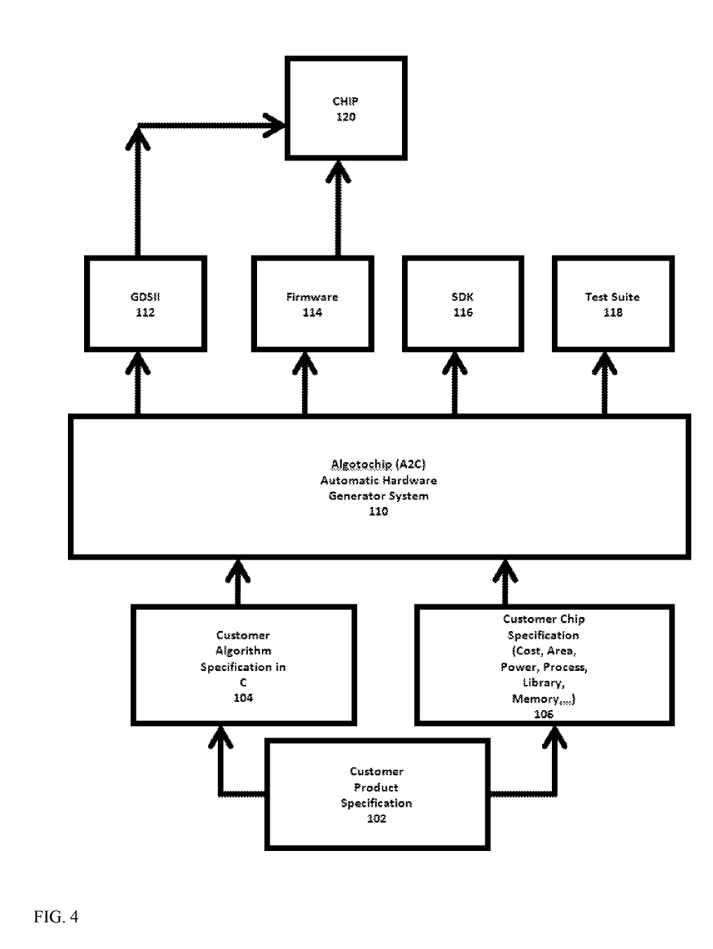

FIG. 4 shows an exemplary system to automatically generate a custom IC. The system of FIG. 4 supports an automatic generation of an architecture for a custom hardware solution for the chosen target application. The target application specification is usually done through algorithm expressed as computer readable code in a high-level language like C/C++, Matlab, SystemC, Fortran, Ada, or any other language. The specification includes the description of the target application and also one or more constraints such as the desired cost, area, power, speed, performance and other attributes of the hardware solution.

In FIG. 4, an IC customer generates a product specification 102. Typically there is an initial product specification that captures all the main functionality of a desired product. From the product, algorithm experts identify the computer readable code or algorithms that are needed for the product. Some of these algorithms might be available as IP from third parties or from standard development committees. Some of them have to be developed as part of the product development. In this manner, the product specification 102 is further detailed in a computer readable code or algorithm 104 that can be expressed as a program such as C program or a math model such as a Mathlab model, among others. The product specification 102 also contains requirements 106 such as cost, area, power, process type, library, and memory type, among others.

The computer readable code or algorithm 104 and requirement 106 are provided to an automated IC generator 110. Based only on the code or algorithm 104 and the constraints placed on the chip design, the IC generator 110 automatically generates with few or no human involvement an output that includes a GDS file 112, firmware 114 to run the IC, a software development kit (SDK) 116, and/or a test suite 118. The GDS file 112 and firmware 114 are used to fabricate a custom chip 120.

The instant system alleviates the issues of chip design and makes it a simple process. The system shifts the focus of product development process back from the hardware implementation process back to product specification and algorithm design. Instead of being tied down to specific hardware choices, the algorithm can always be implemented on a processor that is optimized specifically for that application. The system generates this optimized processor automatically along with all the associated software tools and firmware applications. This whole process can be done in a matter of days instead of years that it takes now. In a nutshell the system makes the digital chip design portion of the product development in to a black box.

In one embodiment, the instant system product can take as input the following:

Computer readable code or algorithm defined in C/Matlab

Peripherals required

Area Target

Power Target

Margin Target (how much overhead to build in for future firmware updates and increases in complexity)

Process Choice

Standard Cell library Choice

Testability scan

The output of the system may be a digital hard macro along with all the associated firmware. A software development kit (SDK) optimized for the digital hard macro is also automatically generated so that future upgrades to firmware are implemented without having to change the processor.

The system performs automatic generation of the complete and optimal hardware solution for any chosen target application. While the common target applications are in the embedded applications space they are not necessarily restricted to that.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method to automatically generate software development tools for an automatically generated processor architecture, comprising:
a. receiving a description of a target processor;
b. automatically generating a target compiler using a compiler generator;
c. automatically generating a target assembler using an assembler generator;
d. automatically generating a target linker using a linker generator;
e. automatically generating a target simulator using a simulator generator;
f. automatically generating a target profiler using a profiler generator;
g. iteratively generating a new processor architecture by changing one or more parameters of the processor architecture until all user constraints or requirements are met using the generated target compiler, assembler, linker, simulator, and profiler, and for each new processor architecture, regenerating the target compiler, assembler, linker, simulator, profiler for the new processor architecture; and
h. synthesizing an optimal generated processor architecture into a computer readable description of the custom integrated circuit for semiconductor fabrication.

2. The method of claim 1, wherein the compiler generator reads in a high level description of the target processor including semantics of instructions in a processor instruction set architecture, wherein the compiler generator builds a model of a target processor pipeline and annotated semantic trees for the instructions, and generates a target compiler for the target processor.

3. The method of claim 2, wherein the target compiler handles call stack layout, register allocation, instruction scheduling, branch prediction, instruction and data prefetching, and optimizations for the target processor.

4. The method of claim 1, wherein the assembler generator reads in an instruction syntax, instruction binary encodings, and potential relocations for the instructions to generate the target assembler.

5. The method of claim 4, wherein the target assembler checks the instruction syntax and encodes instructions in accordance with a processor specifications, and outputs unresolved symbols.

6. The method of claim 1, wherein the target linker generates an object file linker that takes in object files and libraries, and generates an executable file, with all the relocations applied on the object code.

7. The method of claim 1, wherein the simulator generator reads in a machine description including a pipeline structure, an instruction set architecture, semantics of the instructions, and characteristics of each hardware block.

8. The method of claim 7, wherein the target simulator includes a cycle accurate model of the processor, including a cache model, a memory model, and an interrupt model.

9. The method of claim 1, including generating a target debugger using a debugger generator.

10. The method of claim 9, wherein the target debugger handles call stack interpretation, unwinding of a call stack, disassembly of instructions, and number and nature of registers on the target machine.

11. A system to automatically generate software development tools for an automatically generated processor architecture, comprising:
a. means for automatically generating a target compiler using a compiler generator;
b. means for automatically generating a target assembler using an assembler generator;
c. means for automatically generating a target linker using a linker generator;
d. means for automatically generating a target simulator using a simulator generator;
e. means for automatically generating a target profiler using a profiler generator;
f. means for iteratively generating a new processor architecture by changing one or more parameters of the processor architecture until all timing, area, power, and hardware constraints expressed as a cost function are met using the target compiler, assembler, linker, simulator, and profiler, wherein each target compiler, assembler, linker, simulator, and profiler are custom generated for each processor architecture using the respective generator; and
g. means for synthesizing an optimal generated processor architecture into a computer readable description of the custom integrated circuit for semiconductor fabrication.

12. The system of claim 11, wherein the compiler generator reads in a high level description of the target processor including semantics of instructions in a processor instruction set architecture, wherein the compiler generator builds a model of a target processor pipeline and annotated semantic trees for the instructions, and generates a target compiler for the target processor.

13. The system of claim 12, wherein the target compiler handles call stack layout, register allocation, instruction scheduling, branch prediction, instruction and data prefetching, and optimizations for the target processor.

14. The system of claim 11, wherein the assembler generator reads in an instruction syntax, instruction binary encodings, and potential relocations for the instructions to generate the target assembler.

15. The system of claim 14, wherein the target assembler checks the instruction syntax and encodes instructions in accordance with a processor specifications, and outputs unresolved symbols.

16. The system of claim 11, wherein the target linker generates an object file linker that takes in object files and libraries, and generates an executable file, with all the relocations applied on the object code.

17. The system of claim 11, wherein the simulator generator reads in a machine description including a pipeline structure, an instruction set architecture, semantics of the instructions, and characteristics of each hardware block.

18. The system of claim 17, wherein the target simulator includes a cycle accurate model of the processor, including a cache model, a memory model, and an interrupt model.

19. The system of claim 11, including generating a target debugger using a debugger generator.

20. The system of claim 19, wherein the target debugger handles call stack interpretation, unwinding of a call stack, disassembly of instructions, and number and nature of registers on the target machine.
